(19) United States
(12) Patent Application Publication
(10) Pub. No.: US 2022/0239367 A1
(43) Pub. Date: Jul. 28, 2022

(54) METHOD AND SYSTEM FOR SATELLITE DOWNLINK PROPAGATION PREDICTION

(71) Applicant: HUAWEI TECHNOLOGIES CO., LTD., Shenzhen (CN)

(72) Inventor: Michael MAYER, Ottawa (CA)

(73) Assignee: HUAWEI TECHNOLOGIES CO., LTD., SHENZHEN (CN)

(21) Appl. No.: 17/155,211

(22) Filed: Jan. 22, 2021

(51) Int. Cl. H04B 7/185; H04W 24/08

(52) U.S. Cl. CPC H04B 7/18519; H04B 7/18513; H04W 24/08

(57) ABSTRACT

There is provided systems and methods for satellite downlink propagation prediction. The method can provide service continuity for a satellite communication link with a network entity. The method includes collecting, from a plurality of ground facing sensors, data indicative of one or more conditions. The one or more conditions at least in part influencing operational conditions of the satellite communication link. The method further includes predicting an event associated with the operational conditions of the satellite communication link, wherein predicting is at least in part based on the data. The method further includes modifying the satellite communication link based on the predicted event.

### FIELD OF THE INVENTION

The present invention pertains to the field of communication networks, and in particular to systems and methods for satellite downlink propagation prediction.

### BACKGROUND

Evolving satellite networks may use large constellations of low earth orbit (LEO) satellites to provide ubiquitous ground coverage with low latency. These satellite network systems differ from smaller systems of geosynchronous satellites and may offer a better user experience due to the low transmission times. While many satellite constellations rely on optical inter-satellite links (ISLs) for communication between satellites, the use of optical ISLs may not always be feasible due to tracking complexity and cost. The use of an optical link for communication to ground stations is considered to be unstable as the link may be interrupted by a number of intermediate objects (including clouds). In addition, optical links are typically narrow resulting in a small coverage footprint. As a result, ground links are expected to be radio links. Although less prone to atmospheric effects, weather events can still impact the ability to transmit over radio links. As such, radio link availability may be an issue due to channel conditions, including weather events.

Therefore, there is a need for a system and methods for satellite downlink propagation prediction that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An aspect of the disclosure provides for method and system for satellite downlink propagation prediction. In accordance with embodiments, there is provided a method, executed at a network node, for providing service continuity for a satellite communication link with a network entity. The method includes collecting, from a plurality of ground facing sensors, data indicative of one or more conditions, the one or more conditions at least in part influencing operational conditions of the satellite communication link. The method further includes predicting an event associated with the operational conditions of the satellite communication link, the predicting at least in part based on the data and modifying the satellite communication link based on the predicted event.

In some embodiments, the event is a link impairing event, wherein the method further includes configuring one or more back up satellite communication links. In some embodiments, modifying the satellite communication link based on the predicted event includes rerouting traffic from the satellite communication link to the one or more back up satellite communication links.

In some embodiments, the method further includes preconfiguring a second satellite communication link for routing traffic. In some embodiments, the event is a link impairing event and modifying the satellite communication link based on the predicted event includes routing traffic from the satellite communication link to the preconfigured second satellite communication link.

In some embodiments, the method further includes receiving a routing policy, wherein the modifying the satellite communication link based on the predicted event includes modifying the satellite communication link based on the routing policy.

In some embodiments, predicting includes processing, using machine learning, the data to model the communication link. In some embodiments, the processing is performed locally by a satellite, wherein the satellite comprises a first set of ground facing sensors included in the plurality of ground facing sensors. In some embodiments, further includes receiving, from one or more network entities, additional data indicative of the one or more conditions, wherein the predicting is at least in part based on the data and the additional data.

In some embodiments, the method further includes sending the data to one or more network entities for further processing, the one or more network entities comprising: a satellite, a gateway, and a ground station.

In accordance with embodiments there is provided a method for managing satellite network connectivity. The method includes collecting, by a network entity from one or more other network entities, data indicative of one or more conditions, the one or more conditions at least in part influencing operational conditions of one or more satellite communication links. In some embodiments, the method further includes predicting, by the network entity, one or more events associated with the operational conditions of the one or more satellite communication links, the prediction at least in part based on the data. The method further includes sending, by the network entity, instructions to the one or more other network entities, the instructions based on the predicted one or more events.

In some embodiments, predicting one or more events comprises establishing one or more areas of concern for the one or more satellite communication links.

According to embodiments, there is provided an apparatus including a processor and a memory having stored thereon machine executable instructions which when executed by the processor configure the apparatus to perform one or more of the above defined methods.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates the use of ground-facing sensor for predicting transient atmospheric events according to an embodiment of the present disclosure.

FIG. 2 illustrates satellite route protection, according to an embodiment of the present disclosure.

FIG. 3 illustrates a method of service continuity for a satellite communication link according to an embodiment of the present disclosure.

FIG. 4 is a schematic diagram of an electronic device that may perform any or all of operations of the above methods and features explicitly or implicitly described herein, according to different embodiments of the present disclosure.

It will be noted that throughout the appended drawings, like features are identified by like reference numerals.

### DETAILED DESCRIPTION

Embodiments may provide means for predicting satellite outages due to anticipated channel degradation (e.g., due to weather events) and pro-actively responding to such outages before their occurrence. Embodiments may provide means for using information gathered from satellite mounted sensors to determine a propagation model to allow pro-active rerouting of connections to increase overall network availability.

A satellite constellation that acts as a data network may be referred to as a satellite network and may include multiple satellites connected to form a mesh. Typically, the one or more satellites in the satellite network may have multiple interfaces to connect to other satellites and to terminals, including users, on the ground. For typical use, the interface between the ground-terminal and the satellite network is expected to be a radio interface. Depending on the frequency band, the atmosphere may have a significant performance impact on the ground channel and can therefore be a performance factor in the ability to support services over the satellite network.

Existing methods for dealing with ground-satellite links and their availability have generally been indirect and reactionary. Existing methods are typically based on detection of bit errors (leading to full channel failures) or hard outage failures at a service interface, and then initiate mitigation actions, for example, changing traffic to an alternate path. However, such methods may still lead to temporary outages during detection and initiating action stages.

As discussed above, ground-satellite links may be sensitive to atmospheric conditions and outages may occur as a result, for example, during rain or cloud. Further, depending on the downlink frequency used in the ground-satellite link, the degree of link degradation may vary. In some embodiments, the link degradation may be minor, and the link may not require modification. In some embodiments, the link degradation may be significant, and the link may require rerouting, or the data path may need to be transferred to an alternative available path.

While traditional satellites use Ka and Ku bands, there has been increasing interest to use the V band for satellite downlinks. Ku-band may use frequencies in the 12 to 18 gigahertz (GHz) range, while Ka-band may use frequencies in the 26.5 to 40 GHz range. The V-band may use frequencies in the 40 to 75 GHz ranges. It is known that Ka and V bands are sensitive to water vapour and in some cases, may lead to diurnal fading. As such, tropical locations may be more problematic for Ka and V bands.

Embodiments may provide for satellites equipped with ground facing sensors to allow for the detection and prediction of transient fading events. The deployment of sensors on a satellite may be needed to characterize transmission impairments, or events, that may be present between the satellite and a terminal. A terminal may be fixed or mobile and may include a ground-based user or station, for example, an end user, or in the case of providing broad-band service, a gateway. In a satellite network, a terminal may connect to a satellite that is directly above, or in close proximity to the terminal.

Although the interface between the ground-terminal and the satellite network is expected to be a radio interface, embodiments are not limited to a radio interface and may equally be applied to other cases including embodiments where free-space optical links are used.

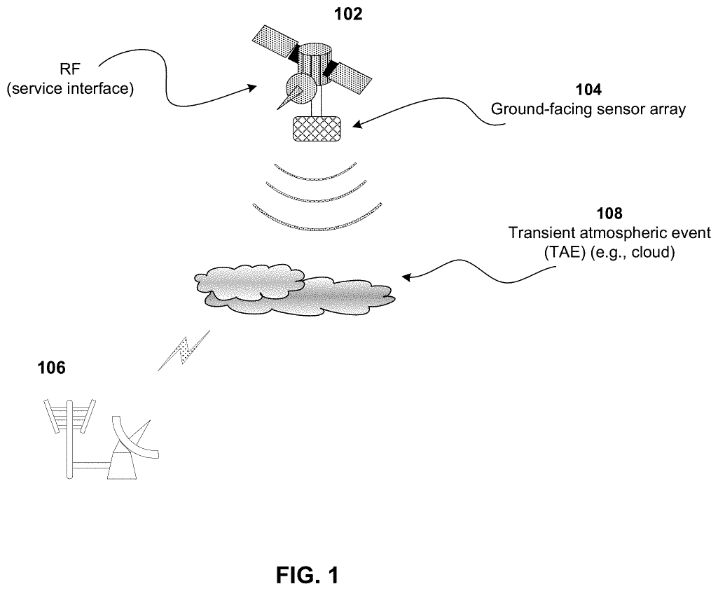

FIG. 1 illustrates the use of ground-facing sensor for predicting transient atmospheric events according to an embodiment of the present disclosure.

Satellite 102, which may form part of a satellite network, may be connected to a ground terminal 106 via a ground-satellite link. Satellite 102 may be equipped with one or more ground facing sensors 104 (e.g., infrared (IR) sensors, doppler radar sensors, visible spectrum sensors) for collecting data related to atmospheric conditions. The collected data may be processed locally at the satellite 102 for predicting one or more events that may impair the ground-satellite link, such as transient atmospheric events (TAE) (e.g., cloud). In some embodiments, the collected data may be transferred to a ground station 106 for processing.

In some embodiments, the processing of the collected data may indicate that a link-impairing event is anticipated and thus the routing system may reroute the traffic to an alternative path before the link-impairing event occurs. In some embodiments, the processing of the collected data may not indicate that a link-impairing event is anticipated, and thus no rerouting may be needed.

Embodiments may provide for an enhanced satellite network including one or more satellites equipped with sensors to provide a high resolution, massive sensor network. The sensor network may provide useful information for predicting a link outage and enable the proactive changing of data routes before an outage can occur. Accordingly, data carried over the satellite network may be rerouted before an outage can occur to maintain service continuity.

Embodiments may further relate to ground-satellite links and may provide for alternate network gateways for selection for data routing. Such alternate network gateways may to be chosen in anticipation of an event, rather than as a reaction to an event that has occurred. Accordingly, packet losses that may occur due to the detection process in a traditional reactionary system may be avoided.

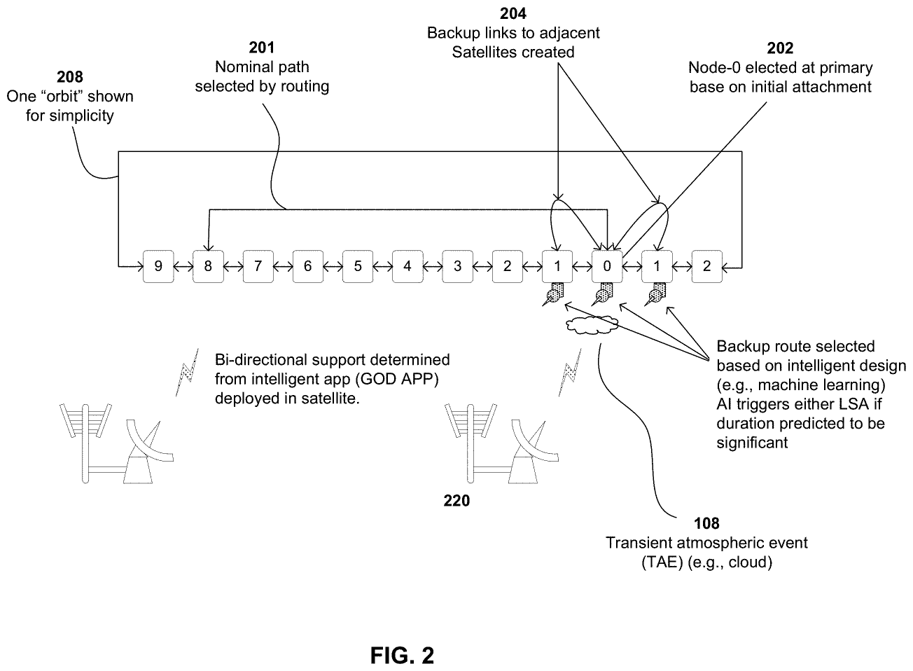

FIG. 2 illustrates satellite route protection, according to an embodiment of the present disclosure. A nominal path 201 may be selected for data routing. The route may include the satellite-terminal link between satellite 202 at node 0 and terminal (e.g., gateway 220). Sensors, including ground-facing sensors, attached to one or more satellites in orbit 208, may collect data indicative of one or more conditions related to satellite-terminal links, including satellite-terminal link between satellite 202 at node 0 and terminal (e.g., gateway) 220. In some embodiments, one or more satellites in orbit 208, for example satellite 202 at node 0 and satellites 204 at nodes 1, may share sensor-collected data among each other for processing. In some embodiments one or more satellites in orbit 208 may transfer the sensor-collected data to a ground station or a gateway 220 for processing.

Collected sensor-data may be processed locally at each satellite to predict one or more link-impairing event, such as a TEA. For example, each satellite 202 at node 0 and satellites 204 at nodes 1, may process the data collected from one or more sources (e.g., sensors, adjacent satellites, etc.). Data processing may indicate that a link-impairing event 108 is anticipated or predicted and the satellite-terminal link between satellite 202 at node 0 and terminal (e.g., gateway 220) may be impaired. In response to such a prediction, the routing system may proactively prepare back up links to ensure route protection. For example, the routing system may prepare or configure backlinks from satellites 204 at nodes 1 to terminal (e.g., gateway 220) before the occurrence of the link-impairing event 108. Accordingly, the routing system may reroute, proactively (prior to the occurrence of the TAE 108), the nominal path 201 from satellite 202 at node 0 to one both of satellites 204 at nodes 1. Accordingly, the satellite route or the network-terminal link is maintained.

In some embodiments, the terminal may communicate with more than one satellite at any given time to facilitate service handoff in a manner that provides continuous service. Similarly, a terminal connected to, for example, the internet, may send data packets to the satellite network for forwarding over one or more satellites to a ground-station that provides connectivity to the internet. The ground-station may then forward the data packet towards the desired destination.

In the particular case of a gateway, the connection between a terminal, such as a mobile user, and a destination end point may also be provided over multiple gateways. Thus, if a gateway is blocked from accessing the satellites, the mobile user may be able to reach the desired end point through a geographically distant gateway. For example, a mobile user in Montana may wish to reach an internet-based service hosted on a server farm in New York. The routing system may determine that a gateway in Newark is to be chosen for such connection. However, the gateway in Newark may be fully isolated due to potential connection issues. The routing system may then choose a gateway in Virginia to reach the server farm in New York. The final leg from the gateway in Virginia would be carried over the internet connection to its final destination in New York.

Embodiments may provide for characterizing one or more transmission channels of a satellite network via ground-facing sensors attached to one or more satellites within the satellite network. The specific sensor wavelength may be chosen based on a desired spectrum. In addition, local interface reported data such as bit error rate, signal to noise ratio etc. may also be used in characterizing a transmission channel. For the purposes of selling the output data, visible data may also be collected, in which case, either or both raw and processed data may be sold.

Data that may be used for characterizing the one or more transmission channels is not limited to data generated from the sensors attached to the satellite network but may also include data from other sources. For example, data from weather monitoring services may also be used to characterize transmission channels. In some embodiments, data, from a variety of sources, which may be indicative of one or more conditions that may affect or be affecting one or more transmission channels may be used for predicting a link-degradation event, such as a transient atmospheric event.

Sensor data representing the view of the one or more downward facing sensors, can be either processed locally or transferred to the ground for subsequent processing. Sensor data from different satellites may be exchanged between adjacent satellites and other satellites in the satellite network to allow local processing, for example local processing the data on each of the satellites. Data may also be exchanged on the ground which may further be aggregated to provide a global view of the communication network. A global view may be useful in developing specific policies for individual satellites. For example, satellites may adopt a policy to attempt to reach a terminal over a different wavelength, (e.g., a wavelength which is less sensitive to the channel impairments), or to choose a different gateway satellite entirely (e.g., a gateway satellite may be a satellite that allows direct connection to a ground gateway).

In some embodiments, data processing may indicate that a downlink connection may need to be entirely removed from being considered for the communication path. Depending on the circumstances, the need to remove a downlink entirely may be performed by directly modifying routing tables, either immediately, or if an almanac function is used, at the next planned update.

In some embodiments, a control system may be configured, for example using artificial intelligence, machine learning techniques or other algorithmic techniques, to provide a wider global scope for establishing areas of local concern relating to connectivity within the communication network

In some embodiments, a processing function may be configured to maintain a list of satellites that have possibly compromised downlink capability. A satellite routing system may be augmented to periodically check the list of satellites and then set up, if necessary, alternate paths between the sending satellite and the satellite closest to the gateway. This information (i.e., the setting up of alternate paths) may be sent to both the target (intended) primary gateway satellite and the alternate satellite. The primary gateway may provide periodic or continuous monitoring on a local basis and then, in the case of an anticipated impairment or event (e.g. proximity of a cloud), the primary gateway may perform a local rerouting action to an alternate path by communicating with the satellite responsible for the alternate path.

In some embodiments, local processing of information at a satellite may indicate that there are no predicted issues with the downlink connection. In this case, the satellite may report to a ground segment that there are no predicted issues without sending the associated data. In some embodiments, the processing may also include communication with other satellites to provide an early warning that the other satellites may be passing over areas of concern, such as, by way of non-limiting examples, storm cells or areas of heavy cloud cover, at some time, or during a time window, in the future. This warning transmission may be performed by assigning to each event a globally unique geographic token. The satellite receiving this token can begin monitoring the event and pass the token to the next satellite as appropriate. The need to update the token may be based on the relative movement of the impairment or event (e.g. cloud) and the satellite. For low earth orbit satellites, the impairment or event may appear fixed relative to the transit time of the satellite. In such cases, the token may not be updated, but simply used to announce to one or more neighboring satellites that they can expect to encounter an impairment or event.

Accordingly, embodiments may provide for the notifying or warning of one or more network entities (e.g., satellites, ground stations, etc.) of a presence of potential impairments or events via the use of tokens. A token may be assigned to a specific impairment or event which may enable identification of that particular impairment or event across the communication network. Notifying one or more network entities may provide for the continuous monitoring of potential impairments or events for enabling enhanced availability and throughput.

Embodiments provide for enhancing satellite network service availability. Embodiments provide for the addition of sensors to collect data for the detection of atmospheric properties. Once the data is collected, a global picture of the ground facing propagation channel(s) may be formulated, which can be used to cause local decisions to be made on the selection of appropriate downlink resources (e.g. antennae) or cause wider scale changes to be made by signaling a change to routing tables for the communications.

Embodiments may provide for an enhanced overall availability and throughput of the communication network. As described, one or more satellites may collect data via one or more ground-facing sensors and share the collected data with one or more immediate neighbors. The collected data may also be provided to a centralized ground-based collection system for further aggregation and development of a system wide view of potential communication impairments or events.

In some embodiments, an alternative preconfigured path may be maintained to allow for switching between an existing path and the alternative path. In some embodiments, multiple preconfigured paths may be maintained to further improve the switching performance of the communication network. One or more preconfigured paths may provide for rapid switching or transferring over multiple ground points, depending on one or more factors, including traffic load, anticipated events (e.g. atmospheric events) and other potential impairments or events.

Embodiments may provide for assessing transmission capabilities of a channel between a terminal and a satellite. Transmission capabilities may be assessed by processing data collected via one or more sensors attached to one or more satellites.

Embodiments may further provide for proactive rerouting or switching of one or more transmission paths based on predicted transmission impairments or events. Predicted transmission impairments or events may be determined based on processing, locally at a satellite or at another point in the communication network (e.g., another satellite or a ground station), the collected data. Processing the collected data may also occur at a regional or global scale by aggregating collected data from one or more sources (e.g., satellite, third party servers, such as weather monitoring systems).

Embodiments may further provide for establishing protection regions. Protection regions may be established via ground-based processing of atmospheric data at a region scale for predicting potential transmission impairments or events and establishing protection regions. For example a protection region may define a region wherein communication must be maintained regardless of impairments or events, for example critical communication systems.

Embodiments may further provide for the addition of sensors to 5G antennas for a means of estimating potential impairments or events on a communication system based on atmospheric events.

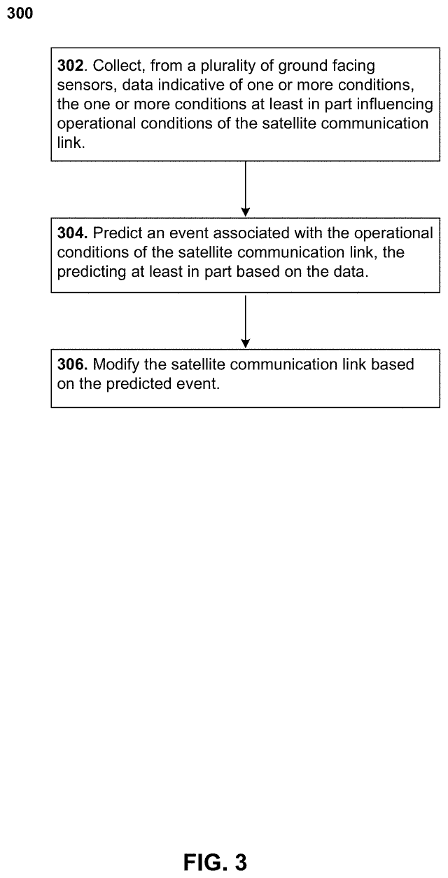

FIG. 3 illustrates a method for providing service continuity for a satellite communication link according to an embodiment of the present disclosure. The methods may be performed by one or more network entities including satellites, ground stations, or gateways.

The method 300 includes collecting, 302, from a plurality of ground facing sensors, data indicative of one or more conditions, the one or more conditions at least in part influencing operational conditions of a satellite communication link. As described in other embodiments, sensors, which may be attached to one or more satellites, may collect data of conditions that may influence or otherwise impair a satellite communication link. In some embodiments, data may be received from one or more other satellites, or other parties that may have collected data indicative of such conditions. Conditions that may influence the satellite communication link may include, among others, atmospheric conditions.

The method 300 further includes, predicting 304, an event associated with the operational conditions of the satellite communication link, the predicting at least in part based on the data. The predicting may include processing the data to model or characterise the satellite communication link. In some embodiments, the processing may also include aggregating the data, where additional data is received from one or more other entities. The processing may include using artificial intelligence and machine learning to characterize the satellite communication link. The processing of the data may indicate that the one or more conditions may impair the satellite communication link. Accordingly, a prediction of a link impairing event based on the one or more conditions may be made. The prediction may indicate the extent of impairment or event including a duration and the likely time when the impairment or event is expected to occur.

The method 300 may further include, modifying, 306, the satellite communication link based on the predicted event. In some embodiments, the predicted event may be a link impairing event, in which the modifying the satellite communication link may include configuring one or more back up satellite communication links and rerouting the traffic from the anticipated impaired satellite communication link to the one or more back up satellite communication links. In some embodiments, the one or more satellite communication links may be preconfigured for allowing rapid switching between the anticipated or predicted impaired satellite communication link to the one or more preconfigured satellite communication link. Depending on the nature of predicted event, the modification of the satellite communication link may be on a routing policy.

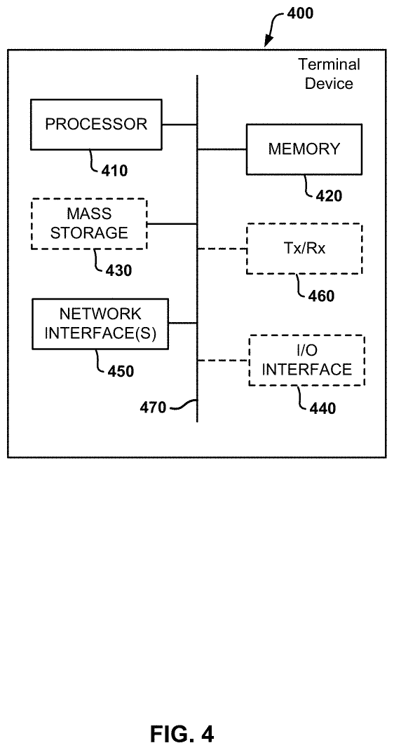

FIG. 4 is a schematic diagram of an electronic device that may perform any or all of operations of the above methods and features explicitly or implicitly described herein, according to different embodiments of the present disclosure. For example, a computer equipped with network function may be configured as electronic device 400. An electronic device may refer to a terminal, a ground station, a mobile device, a satellite or other device with suitable processing power to enable the performance of the desired operations.

As illustrated, electronic device 400 may include a processor 410, such as a central processing unit (CPU) or specialized processors such as a graphics processing unit (GPU) or other such processor unit, memory 420, non-transitory mass storage 430, input-output interface 440, network interface 450, and a transceiver 460, all of which are communicatively coupled via bi-directional bus 470. According to certain embodiments, any or all of the depicted elements may be utilized, or only a subset of the elements. Further, electronic device 400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 420 may include any type of non-transitory memory such as static random access memory (SRAM), dynamic random access memory (DRAM), synchronous DRAM (SDRAM), read-only memory (ROM), any combination of such, or the like. The mass storage element 430 may include any type of non-transitory storage device, such as a solid state drive, hard disk drive, a magnetic disk drive, an optical disk drive, USB drive, or any computer program product configured to store data and machine executable program code. According to certain embodiments, the memory 420 or mass storage 430 may have recorded thereon statements and instructions executable by the processor 410 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method, executed at a network node, for providing service continuity for a satellite communication link with a network entity, the method comprising:
collecting, from a plurality of ground facing sensors, data indicative of one or more conditions, the one or more conditions at least in part influencing operational conditions of the satellite communication link;
predicting an event associated with the operational conditions of the satellite communication link, the predicting at least in part based on the data; and
modifying the satellite communication link based on the predicted event.

2. The method of claim 1, wherein the event is a link impairing event, the method further comprising configuring one or more back up satellite communication links.

3. The method of claim 2, wherein modifying the satellite communication link based on the predicted event comprises rerouting traffic from the satellite communication link to the one or more back up satellite communication links.

4. The method of claim 1 further comprising preconfiguring a second satellite communication link for routing traffic.

5. The method of claim 4, wherein:
the event is a link impairing event; and
modifying the satellite communication link based on the predicted event comprises routing traffic from the satellite communication link to the preconfigured second satellite communication link.

6. The method of claim 1 further comprising receiving a routing policy, wherein the modifying the satellite communication link based on the predicted event comprises modifying the satellite communication link based on the routing policy.

7. The method of claim 1, wherein the event is a link impairing event, the method further comprising:
assigning a geographic token to the event; and
notifying one or more network entities of the event.

8. The method of claim 7 further comprising collecting, by the one or more network entities, data related to the event.

9. The method of claim 1, wherein the plurality of ground facing sensors operate in one or more radio frequency bands.

10. The method of claim 1, wherein predicting comprises processing, using machine learning, the data to model the communication link.

11. The method of claim 10, wherein the processing is performed locally by a satellite, wherein the satellite comprises a first set of ground facing sensors included in the plurality of ground facing sensors.

12. The method of claim 1 further comprising receiving, from one or more network entities, additional data indicative of the one or more conditions, wherein the predicting is at least in part based on the data and the additional data.

13. The method of claim 1 further comprising sending the data to one or more network entities for further processing, the one or more network entities comprising: a satellite, a gateway, and a ground station.

14. A method for managing satellite network connectivity, the method comprising:
collecting, by a network entity from one or more other network entities, data indicative of one or more conditions, the one or more conditions at least in part influencing operational conditions of one or more satellite communication links;
predicting, by the network entity, one or more events associated with the operational conditions of the one or more satellite communication links, the prediction at least in part based on the data;
sending, by the network entity, instructions to the one or more other network entities, the instructions based on the predicted one or more events.

15. The method of claim 14, wherein predicting one or more events comprises establishing one or more areas of concern for the one or more satellite communication links.

16. The method of claim 14, wherein the instructions include routing polices.

17. The method of claim 14 further comprising generating, by the network entity, a list of one or more satellites having one or more compromised communication links based at least in part on the predicted one or more events.

18. The method of claim 17 further comprising:
periodically establishing, by the network entity, one or more alternative communication links for the one or more satellites on the list; and
sending, by the network entity, instructions to the one or more other network entities, the instructions based at least in part on the one or more alternative communication links.

19. An apparatus for providing service continuity for a satellite communication link with a network entity, the apparatus comprising:
a processor; and
a memory having stored thereon machine readable instructions, the machine readable instructions, when executed by the processor configure the apparatus to:
collect from a plurality of ground facing sensors, data indicative of one or more conditions, the one or more conditions at least in part influencing operational conditions of the satellite communication link;
predict an event associated with the operational conditions of the satellite communication link, the predicting at least in part based on the data; and
modify the satellite communication link based on the predicted event.

20. An apparatus for providing service continuity for a satellite communication link with a network entity, the apparatus comprising:
a processor; and
a memory having stored thereon machine readable instructions, the machine readable instructions, when executed by the processor configure the apparatus to:
collect, from one or more other network entities, data indicative of one or more conditions, the one or more conditions at least in part influencing operational conditions of one or more satellite communication links;
predict one or more events associated with the operational conditions of the one or more satellite communication links, the prediction at least in part based on the data;
send instructions to the one or more other network entities, the instructions based on the predicted one or more events.
